(19) United States
(12) Patent Application Publication
(10) Pub. No.: US 2018/0091839 A1
(43) Pub. Date: Mar. 29, 2018

(54) SYSTEM AND METHOD FOR RECORDING STREAMED MEDIA

(71) Applicant: FitCloudConnect Inc., Ottawa (CA)

(72) Inventors: Trevor Sweeney, Ottawa (CA); Brad Weber, Ottawa (CA)

(21) Appl. No.: 15/716,395

(22) Filed: Sep. 26, 2017

Related U.S. Application Data
(60) Provisional application No. 62/399,556, filed on Sep. 26, 2016.

(51) Int. Cl. H04N 21/266; H04L 29/06; H04N 5/91; H04N 5/77; H04N 21/2187; H04N 21/231; H04N 21/4223; H04N 21/61; A63B 71/06; A63B 24/00

(52) U.S. Cl. CPC H04N 21/266; H04L 65/4069; H04N 5/91; H04N 5/77; H04N 21/2187; H04L 67/10; H04N 21/4223; H04N 21/6175; A63B 71/06; A63B 24/0075; H04N 21/231

(57) ABSTRACT

A system for recording fitness sessions including one or more internet-protocol (IP) cameras positioned proximate an exercise location, and a media control appliance in communication with each of the IP cameras. The media control appliance includes a computer processor and a computer-readable storage medium storing instructions which when executed by the computer processor: configures a scheduler module receiving data from a user including a specified exercise location and start and end times of a fitness session, initiates recording video from an IP camera at the specified exercise location at the start time, ends the recording video from the IP camera at the end time; and, stores the recorded video on a media storage medium in communication with the media control appliance.

### TECHNICAL FIELD

The invention relates generally to streaming audio and visual media, and more particularly to recording streamed media based on a scheduling service.

### BACKGROUND

Remote viewable or internet protocol (IP) cameras are widely known and used, for example in situations where remote viewing access to a given area is required, such as a daycare centre permitting parents to view their children, broadcasting lectures from classrooms or conferences and various other analogous applications. Recording these live streams is also known in the prior art, although it is not overly common. One example where this is done is webinar or remote learning lectures where an educator's lecture is often recorded for later viewing by registrants who were unable to attend the live viewing. These recordings are typically triggered on a one-time or case-by-case basis for the purpose of storing a recording of a one-time event. In addition, the recordings are generally made with the intention that an audience of a large group of people may later access the content provided by a single actor to disseminate the content of the single actor to the large group of people.

The prior art does not provide an adequate solution for the counter-use, where a group of individuals are to act in a particular manner for later review by a single actor of a particular purpose. For example, consider a situation where a student's viewing of a webinar is mandatory, and in order to ensure the webinar is not being played without the student present, the educator may wish to have access to a recording of the student being present at his/her computer for the entirety of the lecture time. In another application, and with the advent of video coaching techniques a remote-swim instructor may wish to have recordings of a swim-student's training session for later review. While manual recordings or manually-triggered recordings are possible, they are extremely inefficient and burdensome on all parties involved. One option is to have a constant live stream and recording of the pool area, but this requires a great deal of computing storage resources. There is accordingly a need in the art for an improved method and system for recording streamed video, and more particularly for scheduling, triggering or otherwise facilitating the recording of streamed video.

### SUMMARY OF THE INVENTION

In one embodiment of the invention, there is provided a media control appliance (MCA) including a processor and a computer readable medium which includes computer executable instructions either stored directly thereon or operated from a cloud storage-based service for implementing a camera scheduling service which triggers a recording event for live video and/or audio.

The schedule data is created in the cloud by an authorised user or agent of an authorized user and stored in a computer readable database for later retrieval. The MCA requests the schedule and camera configuration appropriate for a given instance, from the cloud at a user-configurable interval. The schedule data contains a camera configuration identifier, start time and duration. At the defined time the MCA starts recording the media stream for the specified duration. At the completion of the recording the MCA pushes the video resources up into the cloud based storage.

With the aforementioned in mind, in one embodiment of the invention there is provided a system for recording fitness sessions comprising one or more internet-protocol (IP) cameras positioned proximate an exercise location; a media control appliance in communication with each of the IP cameras; wherein the media control appliance includes a computer processor and a computer-readable storage medium storing instructions which when executed by the computer processor: configures a scheduler module receiving data from a user including a specified exercise location and start and end times of a fitness session; initiates recording video from an IP camera at the specified exercise location at the start time; ends the recording video from the IP camera at the end time; and, stores the recorded video on a media storage medium in communication with the media control appliance.

In one aspect of this embodiment, there is further provided one or more internet protocol (IP) audio recording devices associated with each the IP cameras.

In another aspect of this embodiment, at least one of the IP cameras live stream audio and/or video to a display device independently of the start and end times of the fitness session; whereby recording video from the IP cameras live streaming and/or video records a specific time period of the live stream.

In another aspect of this embodiment, the media storage medium is a cloud storage medium accessible over the Internet.

In another aspect of this embodiment, there is further provided a user computer device including a computer processor executing software for receiving user information including the specified exercise location and the fitness session start and end times; the user computer device communicating the user information to the media control appliance.

In another aspect of this embodiment, there is further provided a trainer computer device including a computer processor executing software which permits a trainer to provide suggested fitness session start and end times to the user.

In another aspect of this embodiment, the trainer computer device is authorized by the media control appliance to access the media storage and download and/or view recorded video linked to a specific user.

In another aspect of this embodiment, the user information includes any one or more of a user-name, type of activity being performed, time period of activity, and the intended audience of the video.

In another aspect of this embodiment, the media control appliance further includes camera configuration data used to optimize recordings from particular IP cameras; the camera configuration data including one or more of information on the location of cameras, number of cameras, and operating parameters of the image transmitted by the camera to facilitate characterization of the video and its storage.

In another aspect of this embodiment, stored recorded videos are linked with each of the user information and camera configuration data.

In a second embodiment of the invention, there is provided a method for recording fitness sessions comprising configuring a scheduler module on a media control appliance to receive data from a user including a specified exercise location and start and end times of a fitness session; initiating recording video from at least one IP camera at the specified exercise location at the start time; ending the recording video from the at least one IP camera at the end time; and, storing the recorded video on a media storage medium in communication with the media control appliance.

In one aspect of the second embodiment, the at least one IP camera has at least one IP audio recording device associated therewith.

In another aspect of the second embodiment, at least one of the IP cameras live streams audio and/or video to a display device independently of the start and end times of the fitness session; whereby recording video from the IP cameras live streaming and/or video records a specific time period of the live stream.

In another aspect of the second embodiment, the media storage medium is a cloud storage medium accessible over the Internet.

In another aspect of the second embodiment, the method further includes receiving by the media control appliance from a user computer device user information including the specified exercise location and the fitness session start and end times.

In another aspect of the second embodiment, the method further includes permitting a trainer to provide suggested fitness session start and end times to the user via a trainer computer device.

In another aspect of the second embodiment, the trainer computer device is authorized by the media control appliance to access the media storage and download and/or view recorded video linked to a specific user.

In another aspect of the second embodiment, the user information includes any one or more of a user-name, type of activity being performed, time period of activity, and the intended audience of the video.

In another aspect of the second embodiment, the media control appliance further includes camera configuration data used to optimize recordings from particular IP cameras; the camera configuration data including one or more of information on the location of cameras, number of cameras, and operating parameters of the image transmitted by the camera to facilitate characterization of the video and its storage.

In another aspect of the second embodiment, stored recorded videos are linked with each of the user information and camera configuration data.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 shows a system according to one embodiment of the invention.

FIG. 2 is a flowchart showing a method implemented by the system of FIG. 1.

FIGS. 3A and 3B shows a detailed method according to an embodiment of the invention.

FIG. 4 shows a method as implemented by the scheduler module of the invention.

FIG. 5 shows a system implementing the method of FIGS. 3A and 3B.

FIG. 5 is a screenshot of a scheduler application.

FIG. 6 is a screenshot of a camera configuration module executed by the media control appliance of the invention.

FIG. 7 is a screenshot of a hardware state display in the media control appliance.

### DETAILED DESCRIPTION OF THE INVENTION

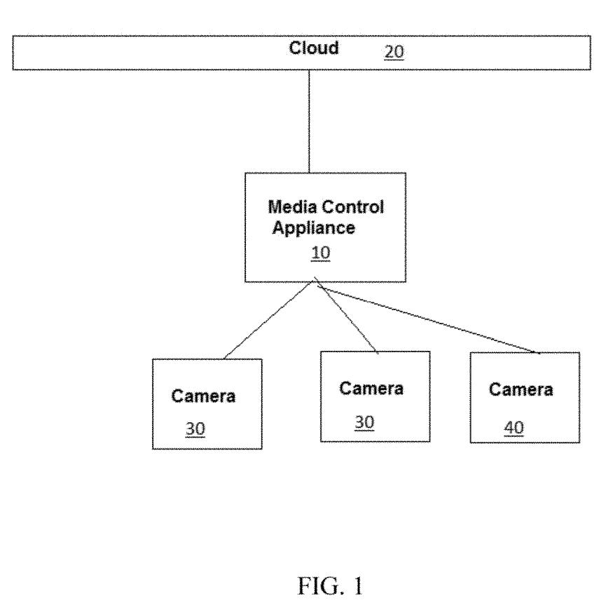

Referring now to FIG. 1, there is shown one embodiment of the invention in which a media control appliance (MCA) 10 is shown in data communication with a computer-readable cloud storage medium 20 and one or more internet-protocol (IP) cameras 30 and/or one or more internet-protocol (IP) audio recording devices 40. The camera and audio recording devices are preferably adapted to live stream audio and/or video to a display device. The display device is not particularly pertinent to the present invention, and is otherwise well known in the art and thus not described in further detail herein. Cloud storage medium 20 may be any computer-readable or accessible cloud storage as is well known.

The MCA 10 is preferably implemented on a computer system having a computer processor and a computer readable medium having computer executable instructions thereon for implementing or executing a software-implemented scheduling service configured to request and obtain schedule information regarding a particular user and information regarding camera configuration for a specific instance. The scheduling service configures the MCA to start recording the media stream based on the schedule information, and upon completion of the recording session, arranges for the recorded video to be stored in cloud-based storage.

The schedule information is stored in any format readable and interpretable by the MCA, such as in an SQL user database. In an exemplary embodiment, schedule information includes any one or more of a user-name, type of activity being performed, time period of activity, and the intended audience of the video. Camera configuration data may include information on the location of cameras, number of cameras, and operating parameters of the image transmitted by the camera to facilitate characterization of the video and its storage.

In one application, a fitness instructor makes use of the recorded video to ensure a client completes a particular workout regime. The client schedules a workout session at a fitness facility with IP cameras installed. The scheduling is done through a user-accessible platform that makes the schedule data available to the scheduling service of the invention. For example, a user logs into a web-interface and defines specific times when s/he will be working out. When the user is scheduled to workout, the MCA triggers the video recording of the video, which may already be streamed, until the workout is scheduled to end, at which point a copy of the recorded video is stored in cloud storage. The instructor can then later review the video for any number of purposes including, but not limited to, ensuring the client completed the workout, provided feedback on the form and technique exhibited by the client during the workout and comparing progress between two or more workouts.

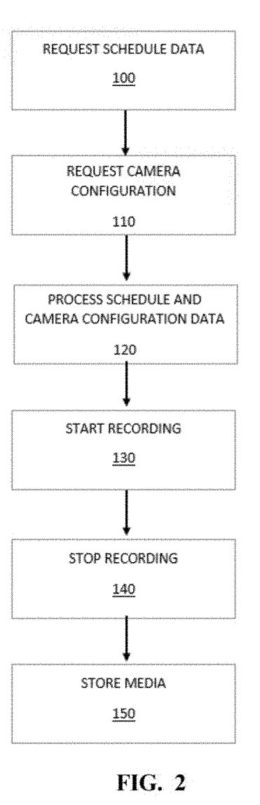

FIG. 2 is a flowchart illustrative of the operation of the invention in which scheduling data is requested at step 100. Preferably, the request for scheduling data is performed at a predetermined interval to capture all schedule data prior to the start of an intended recording event. In one alternative, it is also contemplated that scheduling data could be pushed to the MCA whenever there is a change in data detected. At step 110, camera configuration data is requested for the location at which a scheduled recording event is taking place.

The schedule data and camera configuration are then processed at step 120 so that recording events triggered by the MCA can be queued. Camera configuration data can also be used to ensure the proper format of video recording, desired size of files, stamping recorded videos as being black/white or colour videos, or to apply image and video processing to the recorded video prior to storage. The camera configuration data can also be used to ensure that the proper geographic area is being recorded, and potentially to also mark different views in the case of multiple cameras. For example, recordings of views can be tagged as being taken from the front, from the back, etc.

At step 130, the recording starts for a period of time as determined in the processing of the schedule data, until the recording is stopped at step 140. Finally, the recorded video is stored at step 150, optionally having been processed prior to storage.

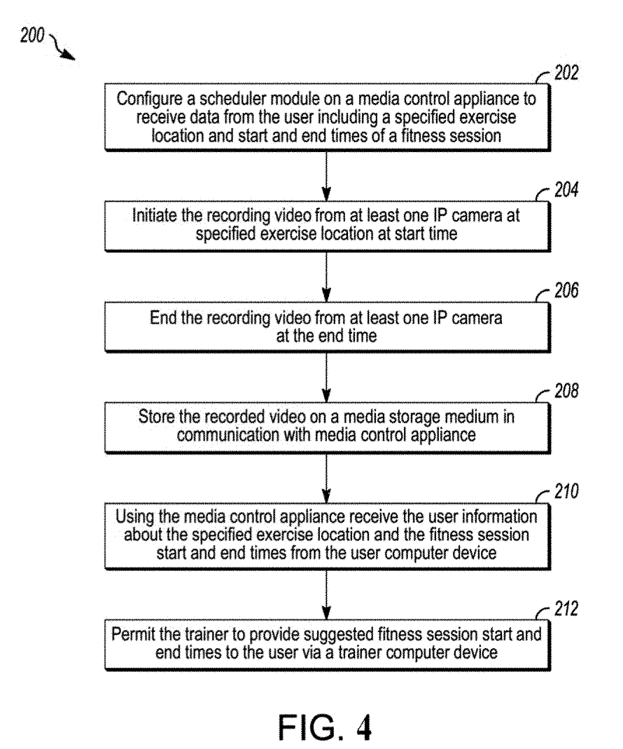

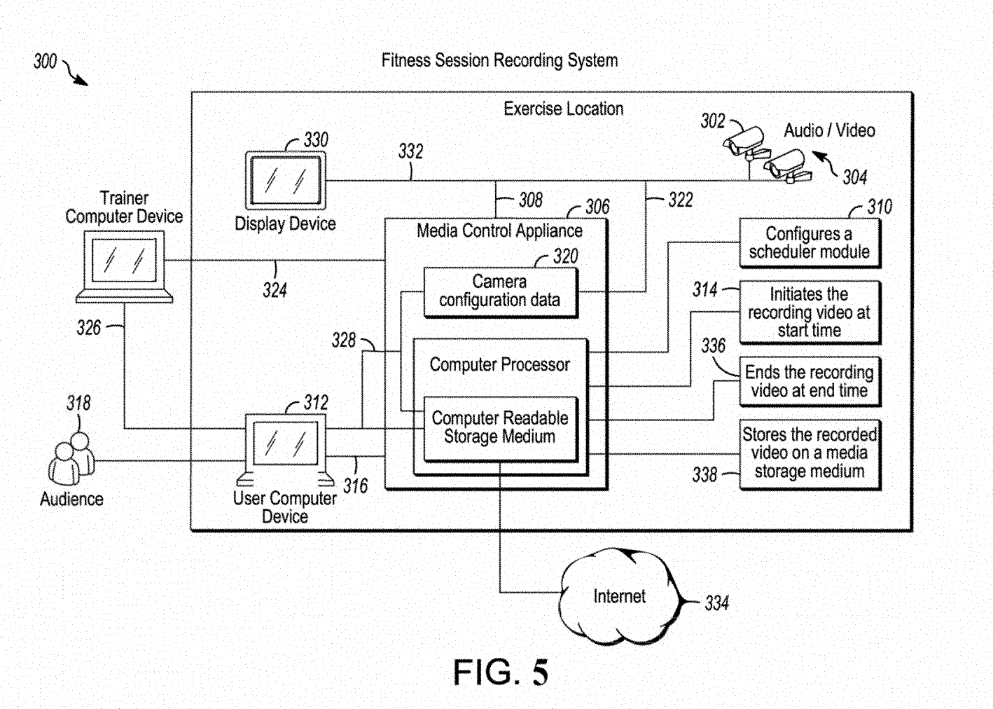

One exemplary system in accordance with the invention is shown in FIG. 5, where there is provided a system 300 for recording fitness sessions comprising one or more internet-protocol (IP) cameras 302 positioned proximate an exercise location. a media control appliance 306 is in communication with each of the IP cameras 302. The media control appliance includes a computer processor and a computer-readable storage medium storing instructions which when executed by the computer processor, which configures a scheduler module 310 receiving data from a user including a specified exercise location and start and end times of a fitness session, initiates recording video from an IP camera at the specified exercise location at the start time 314 and ends the recording video from the IP camera at the end time 336. Finally, the recorded video is stored on a media storage medium in communication with the media control appliance 338.

One or more internet protocol (IP) audio recording devices 304 may be associated with each the IP cameras 302.

The media storage medium is typically a cloud storage medium accessible over the Internet 334.

A user computer device 312 receives user information including the specified exercise location and the fitness session start and end times; the user computer device communicates the user information to the media control appliance via communication link 316, typically also implemented over the internet. Users 318 operate the user computer device.

A trainer computer device 326 permits a trainer to provide suggested fitness session start and end times to the user, or otherwise view stored videos via communication with the media control appliance via communications link 324, which also may be implemented over the Internet.

The trainer computer device is authorized by the media control appliance to access the media storage and download and/or view recorded video linked to a specific user.

A display device 330 may be provided at a fitness facility which live streams video regardless of whether recording is being implemented or not.

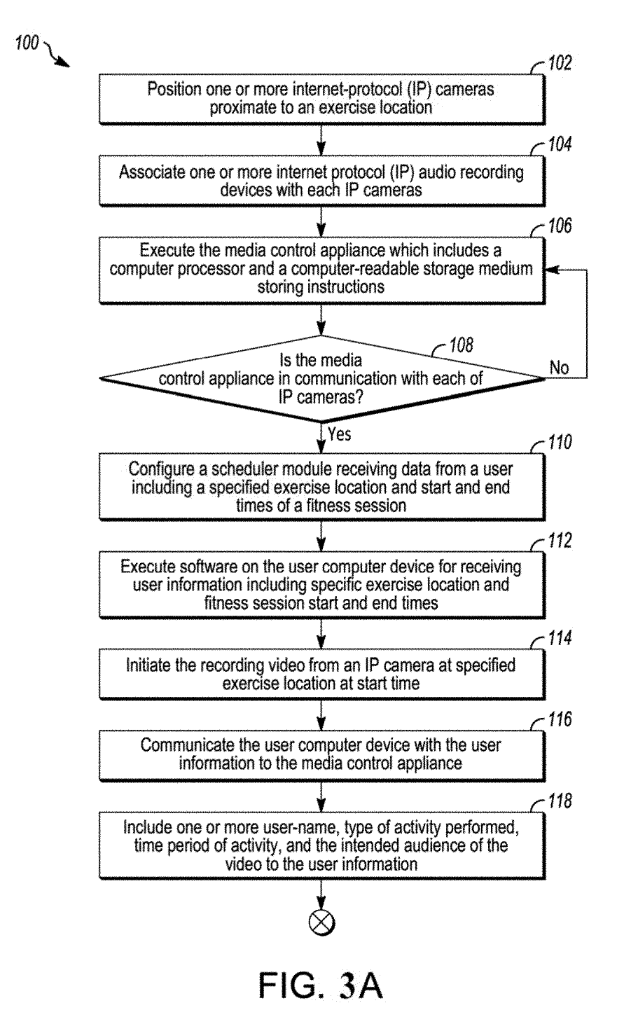

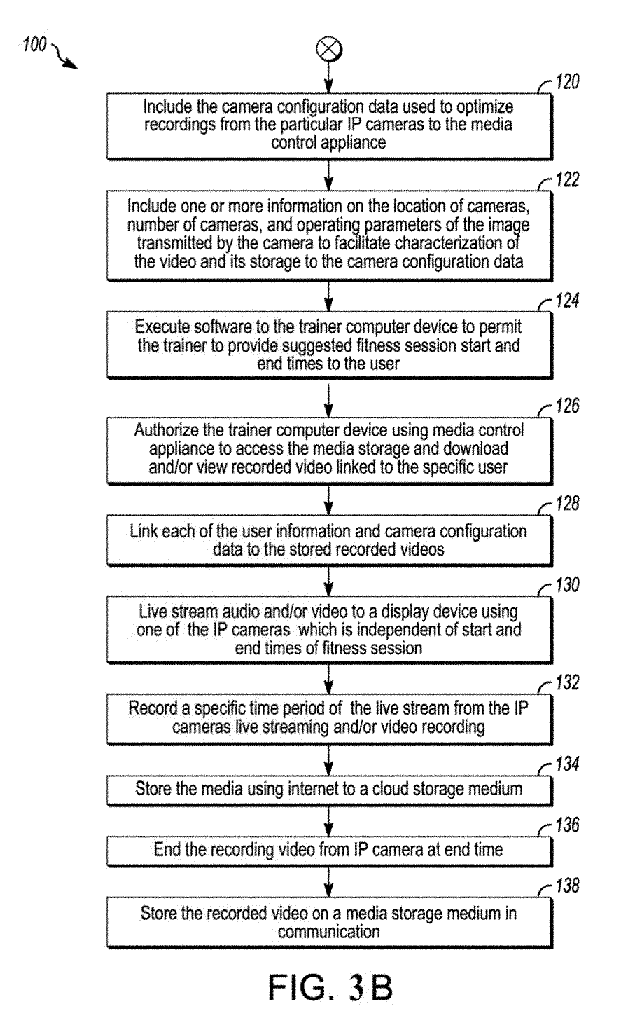

A more detailed method 100 is shown in FIGS. 3A, 3B and 4 in which the method includes providing one or more IP cameras proximate to an exercise location 102, associating one or more audio recording devices with each IP camera 104 (the audio devices may be integral with the camera 102), and initiating operation of a media control appliance 106. The media control appliance determines if the cameras are online at 108 and awaits confirmation of communication prior to proceeding. At step 110, the method includes configuring a scheduler module on a media control appliance to receive data from a user including a specified exercise location and start and end times of a fitness session, executing software on a user computer device for providing user information and/or fitness information 112, and initiating recording video from at least one IP camera at the specified exercise location at the start time 114. The recording is stopped at the session end time at step 136 and stored at step 138.

Various other steps may be including in the method, including those described below. It is also worth noting that the order of these steps are entirely optional and many may also be implemented before recording is started.

The method may include using the camera configuration data used to optimize recordings from the particular IP cameras to the media control appliance at step 120. The configuration data may include one or more information on the location of cameras, number of cameras, and operating parameters of the image transmitted by the camera to facilitate characterization of the video and its storage to the camera configuration data at step 122.

Software may be executed on a trainer computer device to permit the trainer to provide suggested fitness session start and end times at 124, and to authorize the trainer computer device using the media control appliance to access the media storage for viewing and/or downloading videos 126.

User and camera information is linked to respective stored recorded videos at 128.

Live streaming of the video may be independent of recording operation of the media control appliance as shown at 130. However, specific time periods of the live stream are recorded at 132. The video is stored in cloud storage at 134 in real time and the recording stopped at 136. Finally, a completed video may also be stored on a different storage medium at 138.

Operation of a schedule module executed by the media control appliance is shown in FIG. 4, where a scheduler module is configured to receive data from the user regarding a fitness session at 202. A recording is initiated from a specific IP camera at a specific location and time at 204, and the recording ended at a specific time at 206. The recorded video is stored at 208. The media control appliance receives, stores and otherwise processes user and camera data at 210 such that a trainer may provide feedback or suggested future fitness sessions at 212.

IP cameras and recording live streamed video are known in the art, and accordingly specifics of these features are not described in detail herein. However, the scheduling service integrated with the MCA capable of communicating with a user's schedule data and camera configuration data to enable the recording of live streamed video based on the a user's schedule is thought to be novel and inventive over the prior art. The benefits of the invention include the ability to retrieve information from a plurality of sources of schedule data and a plurality of sources of camera identifiers and configuration data to ultimately record events based on schedules of a plurality of users.

In an exemplary computing device which could be used to implement the MCA, the computing device may be configured as a server having one or more hardware units, such as, without limitation a rack server, blade server, and the like. The computing device may also include a network interface, I/O devices, and a system memory. The network interface provides wired or wireless communications between the hardware units and a communication framework. The system memory is used to store programs and data used in operation of the computing device. Each hardware unit may have at least one processor, a communication interface, and a memory. A processor may be any commercially available processor and may include dual microprocessors and multi-processor architectures. The communication interface facilitates communications between the hardware unit and the network interface, I/O devices, and system memory. The I/O devices may include a keyboard, mouse, pointing device, microphone, a sound input device, a touch input device, other devices to receive voice input, touch screen, devices to accept gesture input, printers, display, speakers, and the like.

The memory may be any type of computer-readable storage media or computer-readable storage device that stores executable procedures, applications, and data that does not pertain to propagated signals, such as modulated data signals transmitted through a carrier wave. The memory may be implemented as a memory device (e.g., random access memory, read-only memory, etc.), magnetic storage, volatile storage, nonvolatile storage, optical storage, DVD, CD, floppy disk drive, flash drive, and any combination thereof. The memory may also include one or more external storage devices or remotely located storage devices.

The network of cameras controlled by the media control appliance may also include at least one IP client (not shown) for each camera. Each camera may communicate with a respective IP client through a LAN or through the internet as required. IP clients can communicate with each camera on a LAN using the network camera to enable streaming directly from each camera to an IP client, and/or more preferably to record video directly to a cloud storage, under the direction of the media control appliance. More preferably, each of the IP clients are built into the media control applicant. The media control appliance may communicate with each IP camera on a WAN using a proxy server to set up an internet based connection through the internet. The media control appliance may be in communication with an update server via the internet to receive automatic updates of software and drivers each of the cameras, or for the media control appliance itself.

The system may optionally include a number of automated services instantiated and executed by the media control appliance to operate based on the occurrence of security events, pre-determined schedules, on-demand scheduling and network-based events. A control software module coordinates the automated services and communications there between. For example, and in addition to the scheduling provisions discussed above, the media control appliance may monitor for health events, be integrated with personal biometric modeling appliances or sensors, provide notifications to a user if a workout session is continuing for too long a time period, accumulate data regarding the type of workouts being performed by a user for the purposes of targeted advertisements to a user account, etc.

Each camera includes an IP network discovery service 12, a program that when executed by the media control appliance, functions to sense the presence of the camera and optionally any other IP-enabled devices attached to the camera. IP network discovery services are generally known in the art, and enable automatic discovery of computers, devices, and services on IP networks using industry standard IP protocols to allow devices to automatically discover each other without the need to enter IP addresses or configure DNS servers. Specifically, IP network discovery service enables automatic IP address assignment without an external DHCP server, name to address translation without a DNS server, and service discovery without a directory server.

The media control appliance may also include an HTTP server for serving http web pages to a client station, and to allow a user to download client software and to configure the services of the camera, such as field of view, video recording quality, automatic shut-off timers, and various other settings that may be suggested by a fitness facility or trainer to facilitate monitoring of each workout session. Practically, the media control appliance via its accessible cloud storage includes at least two databases, a media database and a user database (for example in SQL format). Media database may be a flat file database for storing and accessing recorded video files. User database may be a relational database containing data pertaining to video recording schedules, events, and metadata associated with each of the recorded files. The user database also provides fields for a trainer to leave notes or comments associated with the video for long term storage accessible by the user at a later date.

The IP network discovery service is programmed to automatically configure each IP camera once it is detected in the network, from a default configuration stored in the user database. The default configuration for an IP camera may include time stamp choice of compression algorithm, image quality, image size, frame rate, enabling/disabling of motion detection, and enabling/disabling event detection based.

Each IP camera may also be connected to input/output devices, sensors or other sources of environmental information which cause the camera to start recording. These may be door contacts, fire alarms, manual buttons or other manual inputs such as card key reader authorization, or other scheduler triggered events. The scheduler may be a software module implemented within the media control appliance. For example, if the scheduler is set to initiate recording at 10 am, but door contacts indicate the user is early and begins a workout at 9:45 am, then recording may be started in advance of the scheduler time. This guards against the possibility of a user having a watch with a different time, or simply starting a workout at the wrong time. Data related to the event including data characterizing the type of event and reaction to be taken is stored in the user database upon camera discovery and setup, to notify the user of any deviations from the scheduled recording time.

The media control appliance may also include features which manage the storage available, such as a module programmed to become active periodically in order to perform clean-up functions on the media database and/or the user database. The clean-up functions may include eliminating old events and old recorded video files from media database. The clean-up is preferably performed on an oldest date basis, but user options to maintain certain videos may be implemented as well.

The media control appliance may further be configured to create metadata files, such as XML metadata files for events and for recorded video files, and to attach those XML metadata files to the recorded video files.

Furthermore, network control appliance may include an event manager module, configured to monitor events recorded from each IP camera and coordinates actions of the system to correspond to the event. For example, when a camera detects motion, an event notification is sent to the Event Manager. In another example, when a camera detects a tampering event, such as blocking the view of the camera, smashing the camera, or breaking the lens of the camera off, an event notification is sent to the Event Manager. The Event Manager processes the event according to configurable user instructions.

The event manager module may also function to capture events as they are logged by IP camera and to store events in the user database. The schedule module further functions to receive events from the event manager, time stamp the event and initiate media recording based on interactions with the event manager. The schedule module 18 is programmed to initiate video recordings from specific sets of cameras at pre-determined times, as discussed previously.

The media control appliance also includes a media recording module which is a service program configured to direct the recording video files. Media recording module functions to receive an IP address from the scheduler module a selected camera, set up an RTSP streaming media session (audio or video) with the selected camera, and record the video session after appropriate decoding into media database.

The media control appliance may also be configured to organize recorded video session files on the media database, managing disk space and storage blocks to accomplish an efficient storage and subsequent file streaming and/or downloading. Media recorder 10 pre-allocates block space for each video file.

Recorded video files may be later viewed as streaming video files over the LAN or WAN to a client computer device. In selecting recorded video files for streaming, media control appliance functions to respond to search queries received from client computer devices. The search queries are performed on events in the metadata files or on an index of recorded video files.

Alternatively, video files may simply be downloaded either by the user or an authorized user, such as a trainer authorized to provide feedback to a user.

### EXAMPLE 1

A user having a busy life without the ability to commit to routine sessions with a personal trainer on a predetermined schedule, would like the benefits of a trainer to develop a training routine and monitor her workouts. The user subscribes to a service embodying the invention, and downloads scheduling software to a mobile device. The user has three fitness facilities equipped with IP cameras in communication with a media control appliance according to the invention, and also purchases an IP camera to be installed at home and be in communication with the media control appliance via the internet.

Three workouts are scheduled each week, when the user knows time permits for a one-hour workout. The user enters the workout times into the scheduling software on the mobile device, which uploads the schedule (including location information on where the user intends on working out) to the scheduler in the media control appliance. This particular user opts to do one workout a week at a gym near work, another at a gym near her child's daycare and the other at home.

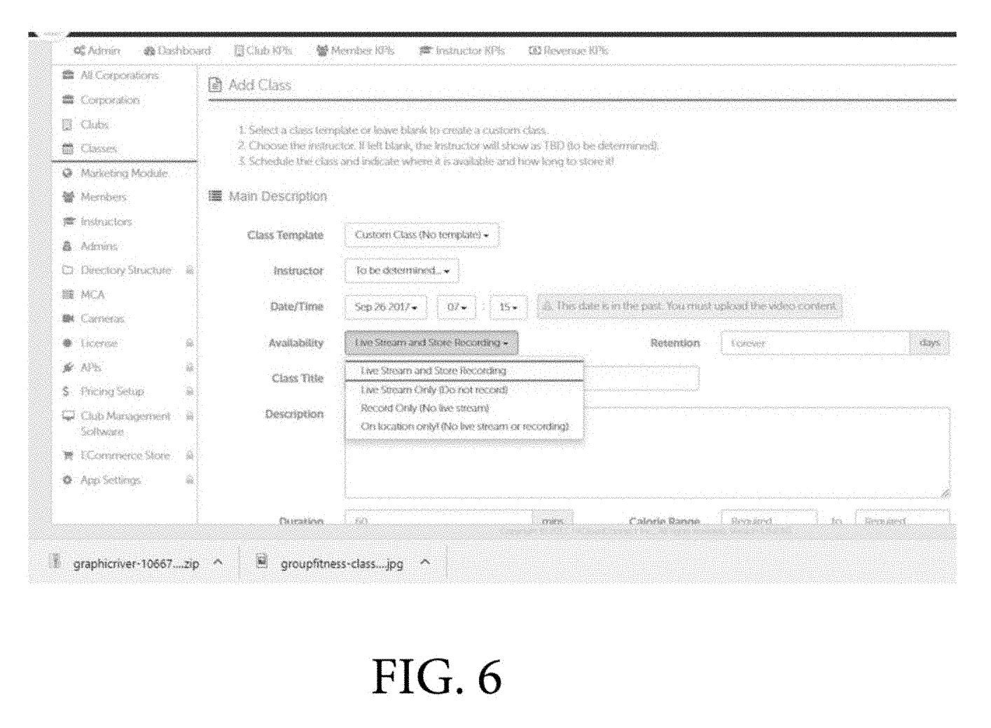

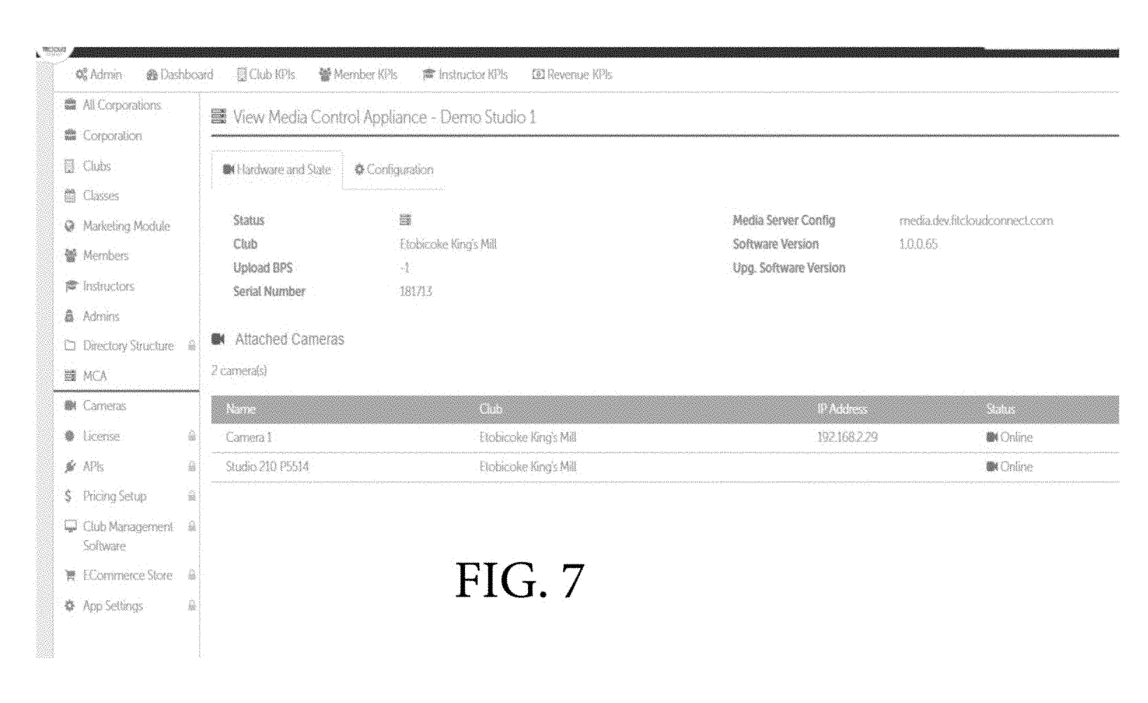

The IP cameras at the gyms are arranged to constantly stream video for security purposes. The IP camera at the user's home is set to turn on to stream and/or record only when triggered to do so. However, as shown in FIG. 6, a gym may provide different operational ability to each of the cameras. The media control appliance is given access to the data in FIG. 6 and can also access the state of each camera as shown in FIG. 7.

The media control appliance starts recording video, either already being streamed or initiates streaming as well, of the appropriate camera during the appropriate time slot as per the scheduler, and stop recording once the scheduled workout time has ended. The video file is saved on accessible cloud storage, with permissions to view the video limited to the user and an appointed trainer; or optionally to other viewers the user may appoint.

It will be apparent to one of skill in the art that other configurations, materials etc may be used in any of the foregoing embodiments of the products, methods, and systems of this invention. It will be understood that the specification is illustrative of the present invention and that other embodiments within the spirit and scope of the invention will suggest themselves to those skilled in the art.

1. A system for recording fitness sessions comprising
one or more internet-protocol (IP) cameras positioned proximate an exercise location;
a media control appliance in communication with each of said IP cameras;
wherein said media control appliance includes a computer processor and a computer-readable storage medium storing instructions which when executed by said computer processor:
configures a scheduler module receiving data from a user including a specified exercise location and start and end times of a fitness session;
initiates recording video from an IP camera at said specified exercise location at said start time;
ends said recording video from said IP camera at said end time; and,
stores said recorded video on a media storage medium in communication with said media control appliance.

2. The system according to claim 1, further comprising one or more internet protocol (IP) audio recording devices associated with each said IP cameras.

3. The system according to claim 1, wherein at least one of said IP cameras live stream audio and/or video to a display device independently of said start and end times of said fitness session; whereby recording video from said IP cameras live streaming and/or video records a specific time period of said live stream.

4. The system according to claim 1, wherein said media storage medium is a cloud storage medium accessible over the Internet.

5. The system according to claim 1, further comprising a user computer device including a computer processor executing software for receiving user information including said specified exercise location and said fitness session start and end times;
said user computer device communicating said user information to said media control appliance.

6. The system according to claim 5, further comprising a trainer computer device including a computer processor executing software which permits a trainer to provide suggested fitness session start and end times to said user.

7. The system according to claim 6, wherein said trainer computer device is authorized by said media control appliance to access said media storage and download and/or view recorded video linked to a specific user.

8. The system according to claim 6, wherein said user information includes any one or more of a user-name, type of activity being performed, time period of activity, and the intended audience of the video.

9. The system according to claim 8, wherein said media control appliance further includes camera configuration data used to optimize recordings from particular IP cameras; said camera configuration data including one or more of information on the location of cameras, number of cameras, and operating parameters of the image transmitted by the camera to facilitate characterization of the video and its storage.

10. The system according to claim 9, wherein stored recorded videos are linked with each of said user information and camera configuration data.

11. A method for recording fitness sessions comprising
configuring a scheduler module on a media control appliance to receive data from a user including a specified exercise location and start and end times of a fitness session;
initiating recording video from at least one IP camera at said specified exercise location at said start time;
ending said recording video from said at least one IP camera at said end time; and,
storing said recorded video on a media storage medium in communication with said media control appliance.

12. The method according to claim 11, wherein said at least one IP camera has at least one IP audio recording device associated therewith.

13. The method according to claim 11, wherein at least one of said IP cameras live streams audio and/or video to a display device independently of said start and end times of said fitness session; whereby recording video from said IP cameras live streaming and/or video records a specific time period of said live stream.

14. The method according to claim 11, wherein said media storage medium is a cloud storage medium accessible over the Internet.

15. The method according to claim 11, further comprising receiving by said media control appliance from a user computer device user information including said specified exercise location and said fitness session start and end times.

16. The method according to claim 15, further comprising permitting a trainer to provide suggested fitness session start and end times to said user via a trainer computer device.

17. The method according to claim 16, wherein said trainer computer device is authorized by said media control appliance to access said media storage and download and/or view recorded video linked to a specific user.

18. The method according to claim 16, wherein said user information includes any one or more of a user-name, type of activity being performed, time period of activity, and the intended audience of the video.

19. The method according to claim 18, wherein said media control appliance further includes camera configuration data used to optimize recordings from particular IP cameras; said camera configuration data including one or more of information on the location of cameras, number of cameras, and operating parameters of the image transmitted by the camera to facilitate characterization of the video and its storage.

20. The method according to claim 19, wherein stored recorded videos are linked with each of said user information and camera configuration data.
